(19) United States
(12) Patent Application Publication
(10) Pub. No.: US 2026/0156061 A1
(43) Pub. Date: Jun. 4, 2026

(54) REAL-TIME FEEDBACK VIA SMARTPHONE CAMERA

(71) Applicant: MaxLinear, Inc., Carlsbad, CA (US)

(72) Inventors: Saju Palayur, Poway, CA (US); Curtis Ling, Carlsbad, CA (US)

(73) Assignee: MaxLinear, Inc., Carlsbad, CA (US)

(21) Appl. No.: 19/405,326

(22) Filed: Dec. 1, 2025

Related U.S. Application Data
(60) Provisional application No. 63/726,658, filed on Dec. 1, 2024.

(51) Int. Cl. H04L 43/0829; H04L 43/065; H04L 43/0888

(52) U.S. Cl. CPC H04L 43/0829; H04L 43/065; H04L 43/0888

(57) ABSTRACT

An access point (AP) may include a processing device. The processing device may receive, at the AP, a video performance capture. The processing device may identify, at the AP, metadata relating to the video performance capture. The processing device may determine, at the AP, a gateway setting based on the video performance capture and the metadata.

### RELATED APPLICATION

This application claims the benefit of U.S. Provisional Application No. 63/726,658, filed Dec. 1, 2024, the disclosure of which is incorporated herein by reference in its entirety.

The examples discussed in the present disclosure are related to real-time feedback via smartphone camera and status display for AI-traffic classification.

### BACKGROUND

Unless otherwise indicated herein, the materials described herein are not prior art to the claims in the present application and are not admitted to be prior art by inclusion in this section.

An access point (AP), is a networking hardware device that allows other Wi-Fi® devices to connect to a wired network. As a standalone device, the AP may have a wired connection to a router, but, in a wireless router, it can also be an integral component of the router itself. There are many wireless data standards that have been introduced for wireless access point and wireless router technology such as Institute of Electrical and Electronics Engineers (IEEE) 802.11a, IEEE 802.11b, IEEE 801.11g, IEEE 802.11n (Wi-Fi® 4), IEEE 802.11ac (Wi-Fi® 5), IEEE 802.11ax (Wi-Fi® 6), and so forth.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some examples, an access point (AP) may include a processing device. The processing device may receive, at the AP, a video performance capture. The processing device may identify, at the AP, metadata relating to the video performance capture. The processing device may determine, at the AP, a gateway setting based on the video performance capture and the metadata.

In some examples, a cloud computing environment may include a processing device. The processing device may receive, at the cloud computing environment, a video performance capture. The processing device may identify, at the cloud computing environment, metadata relating to the video performance capture. The processing device may determine, at the cloud computing environment, a gateway setting based on the video performance capture and the metadata.

In some examples, a station (STA) may include a processing device. The processing device may determine, at the STA, an artificial intelligence (AI) traffic classification status. The processing device may display, at the STA, the AI traffic classification status.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example process flow for an artificial intelligence (AI) and machine learning (ML) system.

FIG. 2 illustrates an example status display for AI traffic classification.

FIG. 3 illustrates a process flow for an artificial intelligence (AI) and machine learning (ML) system.

FIG. 4 illustrates a process flow for an artificial intelligence (AI) and machine learning (ML) system.

FIG. 5 illustrates a block diagram of an example system operable to perform artificial intelligence and machine learning

FIG. 6 illustrates a diagrammatic representation of a machine in the example form of a computing device within which a set of instructions, for causing the machine to perform any one or more of the methods discussed herein, may be executed.

### DESCRIPTION

Video and/or audio performance on a smartphone may suffer from various issues such as jitter, buffering, pixelated video, audio/video sync failure, or the like. Sending metadata related to the jitter, buffering, pixelated video, audio/video sync failure, or the like may not result in enhanced video and/or audio performance. Therefore, other methods of enhancing video and/or audio performance on a smartphone may be useful.

A user may capture video performance and/or audio performance using their smartphone camera while leveraging traffic stats and model data from the access point (AP) as metadata. This combined input enhances the cloud AI/ML system's ability to accurately triage and resolve issues. By combining real-time video feedback with AP traffic stats and metadata, this system ensures accurate issue identification and resolution. It strengthens the AI-driven network's feedback loop, enhancing system performance dynamically and effectively.

In addition, a status display in an app may indicate whether AI traffic classification is active or inactive. This may provide transparency for users and/or operators. This feature may show the AI system's contribution to enhanced performance. This feature may also help operators identify issues and fine tune configurations to facilitate efficient troubleshooting and/or user satisfaction.

Examples of the present disclosure will be explained with reference to the accompanying drawings.

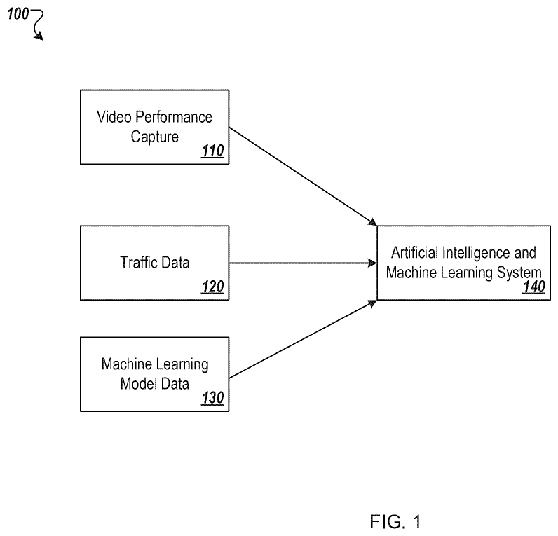

FIG. 1 illustrates process flow 100 for an artificial intelligence (AI) and machine learning (ML) system 140. An access point (AP) may be operable in such a system. The access point may include a processing device. The processing device may receive, at the AP, a video performance capture 110; identify, at the AP, metadata relating to the video performance capture 110; determine, at the AP, a gateway setting based on the video performance capture 110 and the metadata. Video performance capture 110 may be combined with traffic statistics and other model data available on the AP to create a comprehensive dataset. This metadata may be sent to the cloud AI/ML system to provide actionable insights for refining classification, optimizing gateway settings, and addressing network issues.

The video performance capture 110 may include one or more of pixilation, jitter, buffering, audio/video sync failure, or the like. A smartphone app may record video playback, documenting visible artifacts like pixilation, jitter, buffering, or audio/video sync failure. The recorded video playback may be sent to the AP.

The metadata may include AP traffic data 120 which may include one or more of packet loss data, throughput data, or latency data. The AP traffic data (e.g., packet loss, throughput, latency) and the AI model data may be combined for context.

Alternatively or in addition, the metadata may include machine learning model data 130. The machine learning model may be one or more of supervised learning, unsupervised learning, reinforcement learning, or the like. Supervised learning may use one or more algorithms such as support-vector machines, linear regression, logistic regression, naïve Bayes, linear discriminant analysis, decision trees, k-nearest neighbors algorithm, neural networks, similarity learning, or the like. Unsupervised learning may use one or more approaches such as clustering, anomaly detection, latent variable models, or the like. Reinforcement learning may use a value function, Monte Carlo methods, temporal difference methods, function approximation methods, or the like. The models may be trained using any suitable dataset. For example, the models may be trained using historical performance data. Metadata from the AP, along with user-captured footage, may be processed by the cloud AI/ML system to enhance issue triage and optimize classification models.

The processing device may determine, at the AP, a real-time parameter adjustment of a gateway parameter. The app on a user device may combine video and metadata inputs to provide immediate feedback to the AP for fine-tuning gateway parameters. Examples of gateway parameters that may be adjusted include e.g., service set identifier (SSID), network mode (e.g., IEEE 802.11 standard), security mode (e.g., Wi-Fi® protected access (WPA), WPA2, etc), channel settings (frequency band or channel), routing setting, internet protocol (IP) addressing settings, or the like.

The processing device may send, from the AP to a cloud computing environment, the video performance capture 110 and the metadata. Alternatively or in addition, the AP may process the video performance capture 110 and the metadata without sending to a cloud computing environment.

The processing device may generate, at the AP, a report based on the video performance capture 110 and the metadata; and/or send, from the AP to a network operator, the report. That is, the processing device may aggregate and send comprehensive reports, including video, traffic stats, and metadata, to network operators for precise troubleshooting and system updates.

A cloud computing environment may include a processing device. The processing device may receive, at the cloud computing environment, a video performance capture 110; identify, at the cloud computing environment, metadata relating to the video performance capture; and/or determine, at the cloud computing environment, a gateway setting based on the video performance capture 110 and the metadata.

The video performance capture 110 may include one or more of pixilation, jitter, buffering, audio/video sync failure, or the like. The metadata may include AP traffic data including one or more of packet loss data, throughput data, or latency data. The metadata may include machine learning model data.

The processing device may determine, at the cloud computing environment, a real-time parameter adjustment of a gateway parameter. The processing device may generate, at the cloud computing environment, a report based on the video performance capture 110 and the metadata; and/or send, from the cloud computing environment to a network operator, the report.

Modifications, additions, or omissions may be made to the components of FIG. 1 without departing from the scope of the present disclosure.

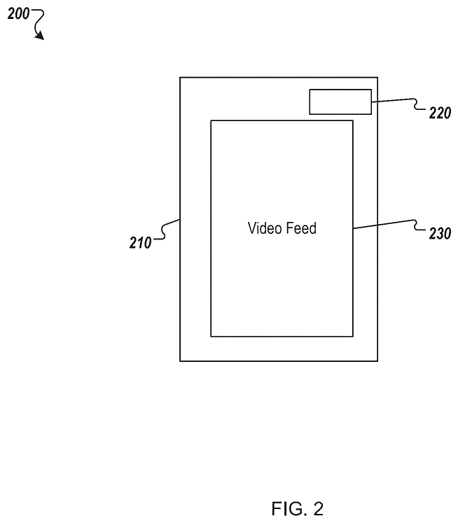

As illustrated in FIG. 2, a block diagram 200 for status display for AI-traffic classification may be provided. A STA 210 may include an AI traffic classification status 220. This feature may provide a status indicator in the app to show whether AI traffic classification is active or inactive, ensuring transparency for users and operators. The application may provide real-time feedback on the status of the AI traffic classification system, helping users correlate network performance with AI-driven optimizations.

The STA may include a processing device. The processing device may determine, at the STA, an artificial intelligence (AI) traffic classification status; and/or display, at the STA, the AI traffic classification status. The AI traffic classification status may be displayed in real-time.

The AI traffic classification status may be displayed near a video feed 230. The AI traffic classification status may be an indicator that may be overlaid on the video feed 230. The AI traffic classification status may display information relating to one or more of packet loss, jitter, artifacts, audio/video syncing failure, or latency-sensitive optimization benefits. The AI traffic classification status may indicate an increase in performance relative to a baseline level (i.e., a performance level in which AI traffic classification is not used). The AI traffic classification status may allow a user to troubleshoot.

For example, the real-time status indicator may display a prominent indicator (e.g., “AI Classification: ON/OFF”) overlaid on or near the video feed 230, making it easy to identify the system's operational state. The status indicator may use content sensitive to network issues, such as packet drops, jitter, or video decoding artifacts, to showcase the impact of AI traffic classification.

Some examples of footage include F1 Racing Footage which may highlight packet loss, jitter, or artifacts during high-speed action. In addition, Twitch Gaming Streams may be used to demonstrate latency-sensitive optimization benefits for real-time interactions.

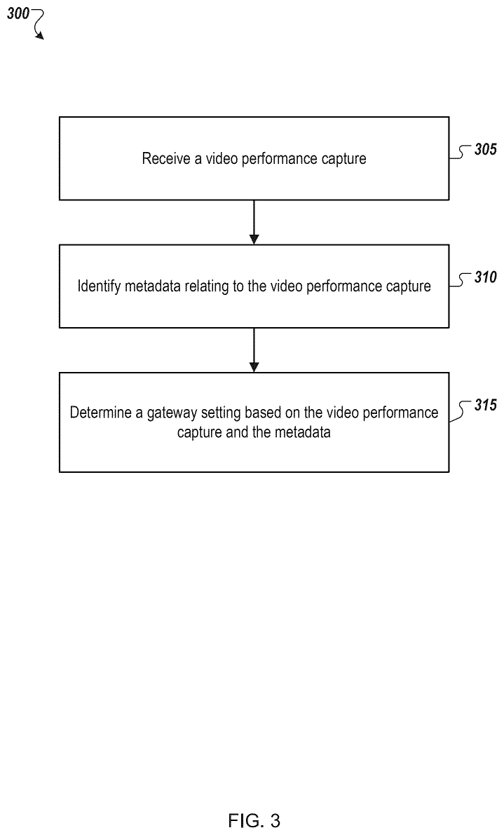

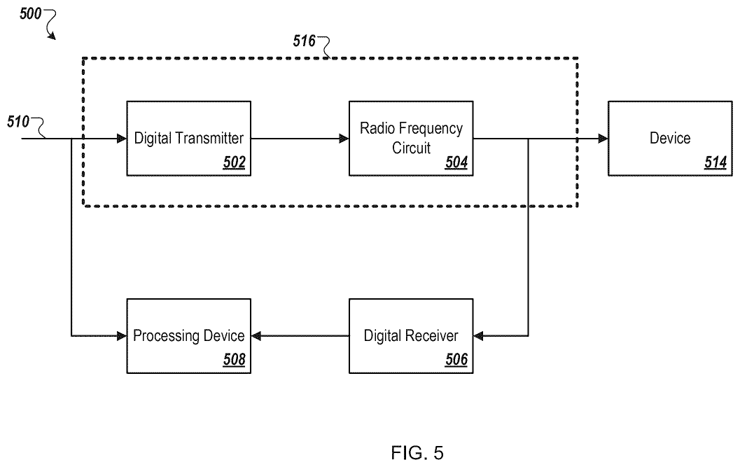

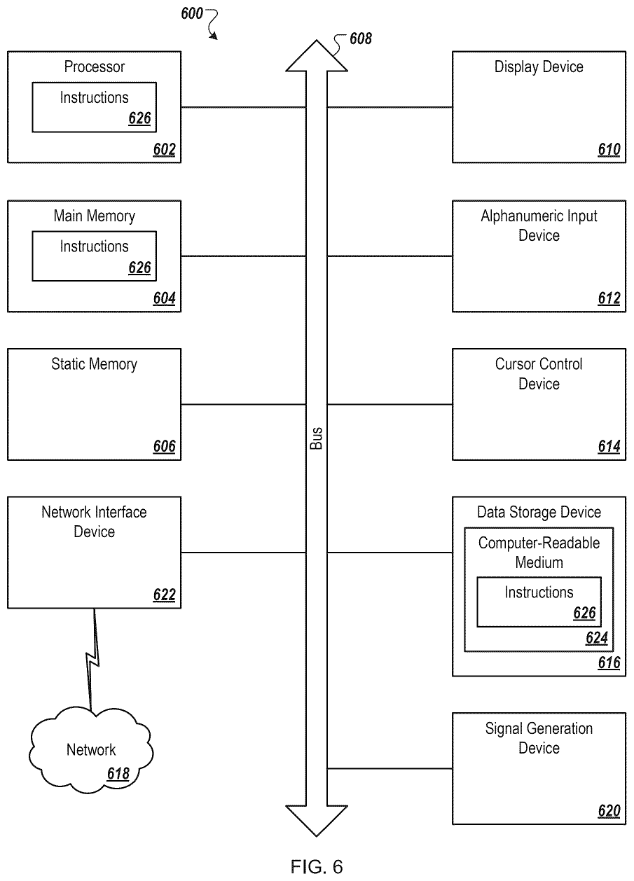

FIG. 3 illustrates a process flow of an example method 300 of real-time feedback via a smartphone camera, in accordance with at least one example described in the present disclosure. The method 300 may be arranged in accordance with at least one example described in the present disclosure. The method 300 may be performed by processing logic that may include hardware (circuitry, dedicated logic, etc.), software (such as is run on a computer system or a dedicated machine), or a combination of both, which processing logic may be included in the processing device 602 of FIG. 6, the communication system 500 of FIG. 5, or another device, combination of devices, or systems.

The method 300 may begin at block 305 where the processing logic may receive, at the AP, a video performance capture.

At block 310, the processing logic may identify, at the AP, metadata relating to the video performance capture

At block 315, the processing logic may determine, at the AP, a gateway setting based on the video performance capture and the metadata.

Modifications, additions, or omissions may be made to the method 300 without departing from the scope of the present disclosure. For example, in some examples, the method 300 may include any number of other components that may not be explicitly illustrated or described.

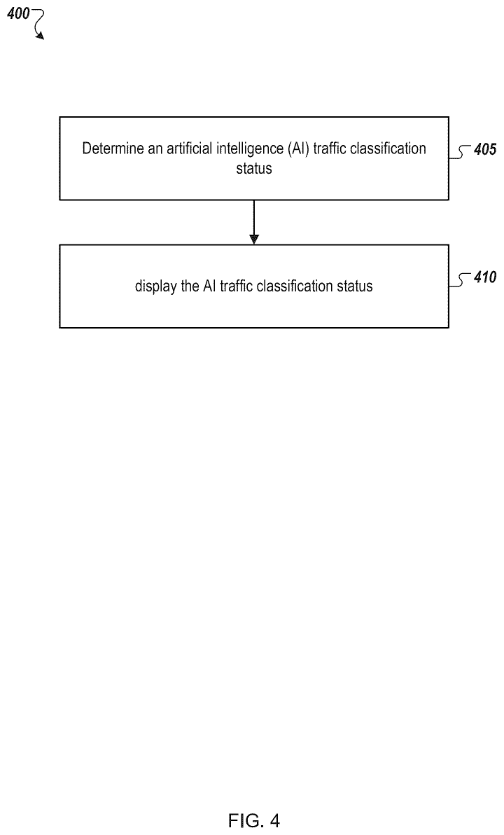

FIG. 4 illustrates a process flow of an example method 400 of AI traffic classification, in accordance with at least one example described in the present disclosure. The method 400 may be arranged in accordance with at least one example described in the present disclosure.

The method 400 may be performed by processing logic that may include hardware (circuitry, dedicated logic, etc.), software (such as is run on a computer system or a dedicated machine), or a combination of both, which processing logic may be included in the processing device 602 of FIG. 6, the communication system 500 of FIG. 5, or another device, combination of devices, or systems.

The method 400 may begin at block 405 where the processing logic may determine, at the STA, an artificial intelligence (AI) traffic classification status.

At block 410, the processing logic may display, at the STA, the AI traffic classification status.

Modifications, additions, or omissions may be made to the method 400 without departing from the scope of the present disclosure. For example, in some examples, the method 400 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 5 illustrates a block diagram of an example communication system 500 configured for real-time feedback via a smartphone camera, in accordance with at least one example described in the present disclosure. The communication system 500 may include a digital transmitter 502, a radio frequency circuit 504, a device 514, a digital receiver 506, and a processing device 508. The digital transmitter 502 and the processing device may be configured to receive a baseband signal via connection 510. A transceiver 516 may comprise the digital transmitter 502 and the radio frequency circuit 504.

In some examples, the communication system 500 may include a system of devices that may be configured to communicate with one another via a wired or wireline connection. For example, a wired connection in the communication system 500 may include one or more Ethernet cables, one or more fiber-optic cables, and/or other similar wired communication mediums. Alternatively, or additionally, the communication system 500 may include a system of devices that may be configured to communicate via one or more wireless connections. For example, the communication system 500 may include one or more devices configured to transmit and/or receive radio waves, microwaves, ultrasonic waves, optical waves, electromagnetic induction, and/or similar wireless communications. Alternatively, or additionally, the communication system 500 may include combinations of wireless and/or wired connections. In these and other examples, the communication system 500 may include one or more devices that may be configured to obtain a baseband signal, perform one or more operations to the baseband signal to generate a modified baseband signal, and transmit the modified baseband signal, such as to one or more loads.

In some examples, the communication system 500 may include one or more communication channels that may communicatively couple systems and/or devices included in the communication system 500. For example, the transceiver 516 may be communicatively coupled to the device 514.

In some examples, the transceiver 516 may be configured to obtain a baseband signal. For example, as described herein, the transceiver 516 may be configured to generate a baseband signal and/or receive a baseband signal from another device. In some examples, the transceiver 516 may be configured to transmit the baseband signal. For example, upon obtaining the baseband signal, the transceiver 516 may be configured to transmit the baseband signal to a separate device, such as the device 514. Alternatively, or additionally, the transceiver 516 may be configured to modify, condition, and/or transform the baseband signal in advance of transmitting the baseband signal. For example, the transceiver 516 may include a quadrature up-converter and/or a digital to analog converter (DAC) that may be configured to modify the baseband signal. Alternatively, or additionally, the transceiver 516 may include a direct radio frequency (RF) sampling converter that may be configured to modify the baseband signal.

In some examples, the digital transmitter 502 may be configured to obtain a baseband signal via connection 510. In some examples, the digital transmitter 502 may be configured to up-convert the baseband signal. For example, the digital transmitter 502 may include a quadrature up-converter to apply to the baseband signal. In some examples, the digital transmitter 502 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 502.

In some examples, the transceiver 516 may include one or more subcomponents that may be used in preparing the baseband signal and/or transmitting the baseband signal. For example, the transceiver 516 may include an RF front end (e.g., in a wireless environment) which may include a power amplifier (PA), a digital transmitter (e.g., 502), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 504) of the transceiver 516 may be synchronized with the resource controller via the S-plane device, which may contribute to high-accuracy timing with respect to a reference clock.

In some examples, the transceiver 516 may be configured to obtain the baseband signal for transmission. For example, the transceiver 516 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 516 may be configured to generate a baseband signal for transmission. In these and other examples, the transceiver 516 may be configured to transmit the baseband signal to another device, such as the device 514.

In some examples, the device 514 may be configured to receive a transmission from the transceiver 516. For example, the transceiver 516 may be configured to transmit a baseband signal to the device 514.

In some examples, the radio frequency circuit 504 may be configured to transmit the digital signal received from the digital transmitter 502. In some examples, the radio frequency circuit 504 may be configured to transmit the digital signal to the device 514 and/or the digital receiver 506. In some examples, the digital receiver 518 may be configured to receive a digital signal from the RF circuit and/or send a digital signal to the processing device 508.

In some examples, the processing device 508 may be a standalone device or system, as illustrated. Alternatively, or additionally, the processing device 508 may be a component of another device and/or system. For example, in some examples, the processing device 508 may be included in the transceiver 516. In instances in which the processing device 508 is a standalone device or system, the processing device 508 may be configured to communicate with additional devices and/or systems remote from the processing device 508, such as the transceiver 516 and/or the device 514. For example, the processing device 508 may be configured to send and/or receive transmissions from the transceiver 516 and/or the device 514. In some examples, the processing device 508 may be combined with other elements of the communication system 500.

FIG. 6 illustrates a diagrammatic representation of a machine in the example form of a computing device 600 within which a set of instructions, for causing the machine to perform any one or more of the methods discussed herein, may be executed. The computing device 600 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 600 includes a processing device (e.g., a processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)) and a data storage device 616, which communicate with each other via a bus 608.

Processing device 602 represents one or more general-purpose processing devices such as a microprocessor, central processing unit, or the like. More particularly, the processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also include one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein.

The computing device 600 may further include a network interface device 622 which may communicate with a network 618. The computing device 600 also may include a display device 610 (e.g., a liquid crystal display (LCD) or a cathode ray tube (CRT)), an alphanumeric input device 612 (e.g., a keyboard), a cursor control device 614 (e.g., a mouse) and a signal generation device 620 (e.g., a speaker). In at least one example, the display device 610, the alphanumeric input device 612, and the cursor control device 614 may be combined into a single component or device (e.g., an LCD touch screen).

The data storage device 616 may include a computer-readable storage medium 624 on which is stored one or more sets of instructions 626 embodying any one or more of the methods or functions described herein. The instructions 626 may also reside, completely or at least partially, within the main memory 604 and/or within the processing device 602 during execution thereof by the computing device 600, the main memory 604 and the processing device 602 also constituting computer-readable media. The instructions may further be transmitted or received over a network 618 via the network interface device 622.

While the computer-readable storage medium 624 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. An access point (AP), comprising:
a processing device operable to:
receive, at the AP, a video performance capture;
identify, at the AP, metadata relating to the video performance capture; and
determine, at the AP, a gateway setting based on the video performance capture and the metadata.

2. The access point of claim 1, wherein the video performance capture includes one or more of pixilation, jitter, or buffering.

3. The access point of claim 1, wherein the metadata includes AP traffic data including one or more of packet loss data, throughput data, or latency data.

4. The access point of claim 1, wherein the metadata includes machine learning model data.

5. The access point of claim 1, wherein the processing device is further operable to:
determine, at the AP, a real-time parameter adjustment of a gateway parameter.

6. The access point of claim 1, wherein the processing device is further operable to:
send, from the AP to a cloud computing environment, the video performance capture and the metadata.

7. The access point of claim 1, wherein the processing device is further operable to:
generate, at the AP, a report based on the video performance capture and the metadata; and
send, from the AP to a network operator, the report.

8. A cloud computing environment, comprising:
a processing device operable to:
receive, at the cloud computing environment, a video performance capture;
identify, at the cloud computing environment, metadata relating to the video performance capture; and
determine, at the cloud computing environment, a gateway setting based on the video performance capture and the metadata.

9. The cloud computing environment of claim 8, wherein the video performance capture includes one or more of pixilation, jitter, or buffering.

10. The cloud computing environment of claim 8, wherein the metadata includes AP traffic data including one or more of packet loss data, throughput data, or latency data.

11. The cloud computing environment of claim 8, wherein the metadata includes machine learning model data.

12. The cloud computing environment of claim 8, wherein the processing device is further operable to:
determine, at the cloud computing environment, a real-time parameter adjustment of a gateway parameter.

13. The cloud computing environment of claim 8, wherein the processing device is further operable to:
generate, at the cloud computing environment, a report based on the video performance capture and the metadata; and
send, from the cloud computing environment to a network operator, the report.

14. A station (STA), comprising:
a processing device operable to:
determine, at the STA, an artificial intelligence (AI) traffic classification status; and
display, at the STA, the AI traffic classification status.

15. The STA of claim 14, wherein the AI traffic classification status is displayed in real-time.

16. The STA of claim 14, wherein the AI traffic classification status is displayed near a video feed.

17. The STA of claim 14, wherein the AI traffic classification status is an indicator that is overlaid on a video feed.

18. The STA of claim 14, wherein the AI traffic classification status displays information relating to one or more of packet loss, jitter, artifacts, or latency-sensitive optimization benefits.

19. The STA of claim 14, wherein the AI traffic classification status indicates an increase in performance relative to a baseline level.

20. The STA of claim 14, wherein the AI traffic classification status allows a user to troubleshoot.
